(19) United States
(12) Patent Application Publication
(10) Pub. No.: US 2010/0317270 A1
(43) Pub. Date: Dec. 16, 2010

(54) MOBILE ABATTOIR

(75) Inventor: Lars Jorgensen, Fort St. John (CA)

Correspondence Address: FULBRIGHT & JAWORSKI L.L.P., 600 CONGRESS AVE., SUITE 2400, AUSTIN, TX, 78701, US

(73) Assignee: GATE TO PLATE FOOD SERVICES, INC., Fort St. John, BC (CA)

(21) Appl. No.: 12/524,423

(22) PCT Filed: Jan. 24, 2008
(86) PCT No.: PCT/CA2008/000155

§ 371 Date: Aug. 26, 2010

Related U.S. Application Data
(60) Provisional application No. 60/886,562, filed on Jan. 25, 2007.

(51) Int. Cl. A22B 7/00

(52) U.S. Cl. 452/52

(57) ABSTRACT

A self-contained mobile abattoir configured for receiving and processing therein slaughtered livestock according to Inspection Agency regulatory standards. The mobile abattoir comprises a towable trailer unit. The interior of the trailer unit comprises a plurality of partitioned interconnected workspaces configured for hygenic performance of skinning and skin disposal, carcass cleaning and inspection, evisceration, viscera separation and inspection, butchering and meat inspection operations. A track rail system depending from the trailer ceiling is configured for moving carcasses about and through the interconnected workspaces. The trailer unit also comprises an enclosed equipment space configured for controllably producing and delivering to the interconnected workspaces at least electricity, compressed air, hot water, chilled water, and refrigeration, and is communicable with a power-generating apparatus. An enclosed staff services area separated from the interconnected workspaces by a sealable door is also provided and comprises at least a lavatory, a washup facility and a changing facility.

### TECHNICAL FIELD

This invention relates to mobile abattoirs. More particularly, this invention relates to mobile abattoirs contained within towable trailer units configured to satisfy federal meat inspection regulations.

### BACKGROUND ART

Concerns about public health and food safety have resulted in strict regulation and inspection of commercial slaughtering and processing of livestock in most countries around the world by national Federal Agencies operating under the auspices of promulgated legislation. As one example, under the United States Federal Food, Drug, and Cosmetic Act, the Food and Drug Administration (FDA) protects consumers against impure, unsafe, and fraudulently labeled food. The FDA has inspection authority over any food in interstate commerce, unless the product is regulated by the United States Department of Agriculture/Food Safety Inspection Service (USDA/FSIS). The regulations require FDA inspection of all facilities and processes involved in slaughtering and processing of food. The FDA requires that all food come from an “approved source and process,” meaning that the facility where the livestock was slaughtered and the slaughter process—not the livestock itself—must be inspected and approved. Most commonly, the approved source is a licensed food establishment, a federally inspected meat plant, or a state-inspected meat plant. The commercial slaughtering and processing of livestock to meat and meat products is regulated by the USDA/FSIS according to the regulations and guidelines set out in the Federal Meat Inspection Act (FMIA) and the Humane Methods of Slaughter Act (HMSA). The FMIA established four major sanitary requirements for the meat packing industry: (a) mandatory inspection of livestock before slaughter, (b) mandatory postmortem inspection of every carcass, (c) set explicit sanitary standards for slaughterhouses, and (d) allowed USDA/FSIS to issue grants of inspection and monitor slaughter and processing operations. The HMSA set regulatory standards for the humane handling and slaughtering of livestock. The USDA/FSIS is responsible for inspection of meat, poultry, processed meats, and poultry products in interstate and foreign commerce under the Federal Meat Inspection Act and the Poultry Products Inspection Act. FSIS inspection is required for all cattle, sheep, swine, goats, ratites, and equines before, during and post-slaughter. At present, FSIS is considering the addition of bison, elk, deer, and other species to the list of animals requiring USDA/FSIS inspection. FSIS inspectors examine each animal before and after slaughter for visible defects that can affect safety and quality of meat and poultry products. The Meat Inspection Act and FSIS regulations require ante-mortem and post-mortem inspection of each animal and daily inspection of processing facilities by FSIS inspectors.

As another example, in Canada, the commercial slaughtering and processing of livestock to meat and meat products is regulated by the Canadian Food Inspection Agency according to the regulations and guidelines set out in the Meat Inspection Regulations 1990 (SOR/90-288) (MIR). As a third example, the European Union (EU) instituted in 2006 a “hygiene package” of 5 laws intended to merge, harmonize and simplify very detailed and complex hygiene requirements with the overall aim to create a single, transparent hygiene policy applicable to all food and all food operators. The basic principles underpinning the new hygiene rules are threefold: (1) the introduction of the “farm to fork” principle to hygiene policy to create a systematic, comprehensive hygiene regime covering all food in all sectors, replacing the current, sector specific, patchwork of rules, (2) food producers should bear primary responsibility for the safety of food, through the use of programs for self-checking and modem hazard control techniques, and (3) all food businesses should be registered. This will allow the controlling authorities to organize better their activities, and to develop and operate risk-based control systems. Imported food and feed products, including wild game from North America, have to meet EU food safety standards, including the hygiene rules. In the case of wild game, CFIA or USDA veterinarians (as appropriate based on country of origin) are called upon to provide the certification required for the entry of such products into EU member countries.

The food safety systems put in place by Federal Regulatory Agencies have evolved to a common science-based framework for the identification and prevention of food safety risks generally referred to as the Pathogen Reduction/Hazard Analysis and Critical Control Points (PR/HACCP) system. PR/HACCP allows for the use of science and technology to improve food safety in order to prevent the introduction of pathogens into products intended for human consumption, and consists of seven principles:
hazard analysis to identify potential food safety risks (hazards),
the identification of critical control points to prevent such hazards,
the establishment of critical limits,
monitoring of the critical control points,
corrective actions if something goes wrong,
verification to assess whether monitoring occurs correctly, corrective actions are taken in time and effectively, etc.
documentation.

Two important critical control points in slaughterhouse operations are the prevention of faecal contamination of carcasses and ensuring the correct temperature of carcasses is maintained during storage. While such critical control points must be identified and monitored by the slaughterhouse operator, Federal Agency veterinarians must be on-site to monitor, verify and report that regulatory standards are met and adhered to during the slaughtering and processing operations. All food business operators need to be registered. Some businesses, such as slaughterhouses and cutting plants, need approval before they can operate. Requirements for the construction and installation of slaughterhouses and cutting plants are less detailed than in previous legislation, but they increase the responsibility of the food business operator who must ensure, for example, the welfare of live animals, humane killing procedures, hygienic working conditions, the prevention of cross-contamination and a safe end product. Ultimately, each commercial processor has the responsibility in cooperation with the appropriate regulatory agency, to ensure production occurs according to the hygiene rules and that the end-product is not contaminated, is stored properly and is safe for human consumption.

However, while such regulations have significantly increased the quality and safety of foodstuffs prepared from livestock and game animals, they present significant challenges to numerous sectors of meat producers and consumers. For example, remote northern communities in North America and Europe have the capability to produce sufficient livestock and game animals to supply continental and international markets in addition to their own requirements. However, large-volume slaughterhouse configured to meet and exceed the stringent regulatory requirements are typically located near highly-populated urbanized regions of North America and Europe, and consequently, shipping costs to transport live animals from remote northern regions are cost-prohibitive. Furthermore, livestock shipped for long distances via rail or overland in crowded confined conditions typically experience enormous physical shipping, jostling and nutritional stresses which significantly lower their glycogen levels and increase the pH levels in the meat. The pH levels in the meat have a direct influence on its shelf life. Also changes in meat pH levels change the properties of the meat for processors. For example, to create a shelf stable product for convenience stores that does not require refrigeration, the meat must have a water activity level of 0.90 and a pH balance of 5.3. This is commonly achieved by raw fermentation prior to cooking. However when the pH levels are elevated as a result of extended shipping stress, achieving the water activity level and pH targets is nearly impossible. Other problems related to shipping stresses are bruises, tears caused by broken bones, and off-flavours as a consequence of extended elevated levels of adrenalin and/or stress hormones and metabolites.

Organic meat producers are additionally required to satisfy additional aesthetic-based consumer-group-imposed standards for producing, slaughtering and processing in order to meet legally-defined Federal regulations for organic food products. In addition to the requirement that organically produced livestock must be supplied with 95% organic feed annually, a more important requirement for organic meat is the welfare of the animal that produces it. The British-based Farm Animal Welfare Council's Charter lists the following rights: (a) freedom from malnutrition, (b) freedom from thermal or physical discomfort, (c) freedom from injury and disease, (d) freedom to express most normal, (e) socially acceptable patterns of behavior, and (f) freedom from fear.

U.S. Pat. No. 5,538,466 (the '466 patent) discloses a towable wheel-carried mobile abattoir that comprises a trailer unit containing an equipment room, a personnel section and three processing stations wherein the first station is configured to receive a slaughtered animal in a hanging position for processing, i.e., evisceration, the second station is provided with a movable processing bench for receiving and skinning thereon the eviscerated animal in a lying position, and the third station is configured for processing (i.e., splitting and quartering) the carcasses in a hanging position. The '466 mobile abattoir is not self-contained but rather, requires more work space than is provided within an enclosed towable trailer. The additional work for a personal room and the first processing area is provided by outward telescoping sidewalls of the trailer which then retract for transport. In addition, the floor and roof sections are hydraulically extendable downward and upward respectively to provide the space required for processing large animals, and are retractable for transport.

### DISCLOSURE OF THE INVENTION

The exemplary embodiments of the present invention are directed to a self-contained towable mobile abattoir configured to satisfy Inspection Agency animal handling and meat processing regulations. The mobile abattoir provides and contains therein the requisite work areas for hygenic processing and inspection of slaughtered animals, along with personnel, cleanup and sanitization facilities, and an equipment room to provide power, water, compressed air, and temperature control utilities.

According to an exemplary embodiment of the present invention, there is disclosed an enclosed self-contained over-road towable reefer-type trailer unit configured for towable engagement and cooperation with a heavy-duty truck tractor. The floor, external sidewalls and roof of the trailer unit are constructed with standard materials by artisans skilled in these arts and are suitably constructed and configured to meet Federal transport regulations. The trailer unit may be provided with a bogie wheel assembly approximate the back end of the trailer unit, and landing gear and a king pin for engaging a fifth wheel assembly approximate the front end of the trailer unit. A power-generating apparatus is mounted on an exterior surface of the trailer unit. A suitable power-generating apparatus is a fuel-powered motor that may be mounted on the front end of the trailer unit. Suitable fuels for powering the motor include diesel, propane and gasoline.

According to another exemplary embodiment of the present invention, the interior of the trailer unit may be partitioned into a plurality of vertically partitioned interconnected workspaces.

According to one aspect, an enclosed equipment room is provided at the front of and extending between the sides of the trailer unit. The equipment room is sealed from the rest of the trailer unit and is accessible from a door in a sidewall of the trailer unit. The equipment room is configured to house a plurality of equipment, instruments and electronic controlling devices for controllably providing utilities exemplified by hot water, cold water, chilled water, electricity, compressed, and refrigeration. Exemplary suitable equipment includes an air compressor, compressed air tanks, water heater, water chiller, chilled water storage, electrical generator, and at least one refrigeration unit.

According to another aspect, there is provided an animal processing area at the rear of and extending between the sides of the trailer unit. The ceiling above the animal processing area is provided with a reinforcing beam extending between the sides of the trailer unit for suspending approximately in the middle between the two sidewalls therefrom, a winch assembly. One side wall in the animal processing area is provided with a closeable gut chute opening adjacent the rear of the trailer unit. At least one sanitizable work bench is provided along a wall section in the animal processing area for use by an inspector for placing and inspecting animal parts and organs thereon. The work bench may be fixed in place, or alternatively, be configured to fold-up or fold-down against the wall section when not in use.

According to yet another aspect, a carcass processing, chilling and storage area may extend between the sidewalls of the trailer unit adjacent the equipment room. The carcass processing, chilling and storage area is accessible through a door provided in a sidewall of the trailer unit. If so desired, the door may be configured as a docking station for communicating with a rear door or alternatively, a side door of another over-road trailer unit.

According to a further aspect, a personnel room may be interposed the animal processing area and the carcass processing, chilling and storage area. The personal area is defined by a first side wall section of the trailer unit, a first end wall extending at about 90° from the trailer unit side wall, separated from a second wall also extending at about 90° from the trailer unit side wall, and an interior wall opposite the trailer unit sidewall interconnecting the first and second end walls. The first side wall separates the personnel room from the animal processing area while the second side wall separates the personnel room from the carcass processing, chilling and storage area. The area between the interior wall of the personnel room and the second side wall of the trailer unit defines a passage way area conjoining the animal processing area and the carcass processing, chilling and storage area. The personnel area is accessible through a doorway provided in the sidewall section adjacent one of the end walls and it is preferable to provide a doorway in the interior wall approximately opposite the doorway into the personnel area through the sidewall section. The personnel room is suitably provided with at least a plurality of staff lockers and a workbench. The workbench may be fixed in place, or alternatively, be configured to fold-up or fold-down against a wall section of the personnel area when not in use.

According to a yet further aspect, the personnel room is provided with a third wall extending between the side wall section and the interior wall wherein the third wall is parallel to and interposed the first and second end walls thereby providing an enclosed area within the personnel area for configuration as a bathroom and wash-up facility. Access into the bathroom and wash-up facility is through a doorway provided in the third wall. The bathroom and wash-up facility is provided with at least a toilet, a fixed-in-place hand-washing basin and a fixed-in-place instrument washing installation comprising at least a sink integrally engaged with and cooperating with a counter.

According to yet another embodiment of the present invention, the interior floor, wall and ceiling surfaces comprise at least one seamless sheet material selected for durability, abrasion and cut resistance, and ease-of-washing, disinfection and sanitization. It is within the scope of the present invention to provide seamless sheet material selected from types of materials as exemplified by stainless steel and extruded aluminium, that satisfy and/or exceed Federal meat inspection regulations for use in abattoirs and slaughterhouses. The interior junctures of the floor and the walls, and the ceiling and the walls are suitably sealably engaged so as to provide a continuous seal between the floor, walls and ceiling to facilitate thorough cleaning, washing, disinfection and sanitization during animal processing if necessary, and before and after use of the mobile abattoir of the present invention and to prevent the accumulation of dust and/or biological debris from the animal and meat processing activities therein and about the junctures. If so desired, a plurality of spaced-apart vents may be provided along the upper edges of the side walls of the trailer unit to provide air circulation when the mobile abattoir is in use. If so provided, the plurality of spaced-apart vents may optionally be fitted with air-filtration apparatus to prevent infiltration of undesirable air-borne elements while the mobile abattoir is in use or in transport or in storage.

According to one aspect, the floor of the mobile abattoir is provided with a recessed elongate channel extending from the carcass processing, chilling and storage area adjacent the wall separating the equipment room from the carcass processing, chilling and storage area, along the passageway into animal processing area where it empties into approximate one end of a trough extending between the sidewalls of the trailer unit adjacent the rear door. The channel is provided with a suitable slope from the carcass processing, chilling and storage area to the animal processing area to enable drainage of liquids from the carcass processing, chilling and storage to the animal processing end. The trough is provided with a suitable slope from the juncture of the trough with channel to the opposite end of the trough. The bottom surface of the trough at the end opposite the juncture with the channel is provided with drain and a discharge valve assembly extending through the floor of the trailer unit.

According to another aspect, the ceiling of the mobile abattoir is provided with a conveying rail track system disposed therefrom.

According to yet another aspect, the mobile abattoir is provided with at least a rolling cradle, a first and second rolling gut wagon, a grey water tank underslung to the trailer unit approximate the rear end of the trailer unit, and a ramp configured to releasably engage the rear door opening of the trailer unit. The cradle assembly is configured to support and transport thereon a slaughtered animal into the animal processing area. The first rolling gut wagon is sized for manoeuvrability about and within the animal processing area, and is configured to receive therein the viscera of an eviscerated animal. The second rolling gut wagon is configured for manoeuvrability about and around a parking lot facility adjacent the mobile abattoir and for communicating with the gut chute opening provided in the mobile abattoir. The grey water tank is configured to releasably engage the underside of the trailer unit approximate the channel drain, and to communicate with the channel drain and discharge provided in the bottom surface of the trough at one end of the trough. The grey water tank is fitted with a discharge valve assembly configured to controllably engage and cooperate with a suitable emptying conduit extending into a suitable receptacle.

### BRIEF DESCRIPTION OF THE DRAWINGS

The present invention will be described in conjunction with reference to the following drawings, in which:

FIG. 1 is a right-side view of one embodiment of the present invention shown engaged with a heavy-duty truck;

FIG. 2 is a left-side view of the embodiment shown in FIG. 1;

FIG. 3 is a cross-sectional top view of the embodiment shown in FIG. 2;

FIG. 4 is a cross-sectional left side view of the embodiment shown in FIG. 2;

FIG. 5 is a cross-sectional end view looking forward into the equipment/utilities room designated as 48 in FIG. 4;

FIG. 6 is an end view of the embodiment shown in FIG. 2;

FIG. 7 is a close-up cross-sectional partial end of another embodiment of the present invention;

FIG. 8 is a cross-sectional end view looking forward toward the staff room and carcass inspection areas designated as 40 and 45 in FIG. 4; and

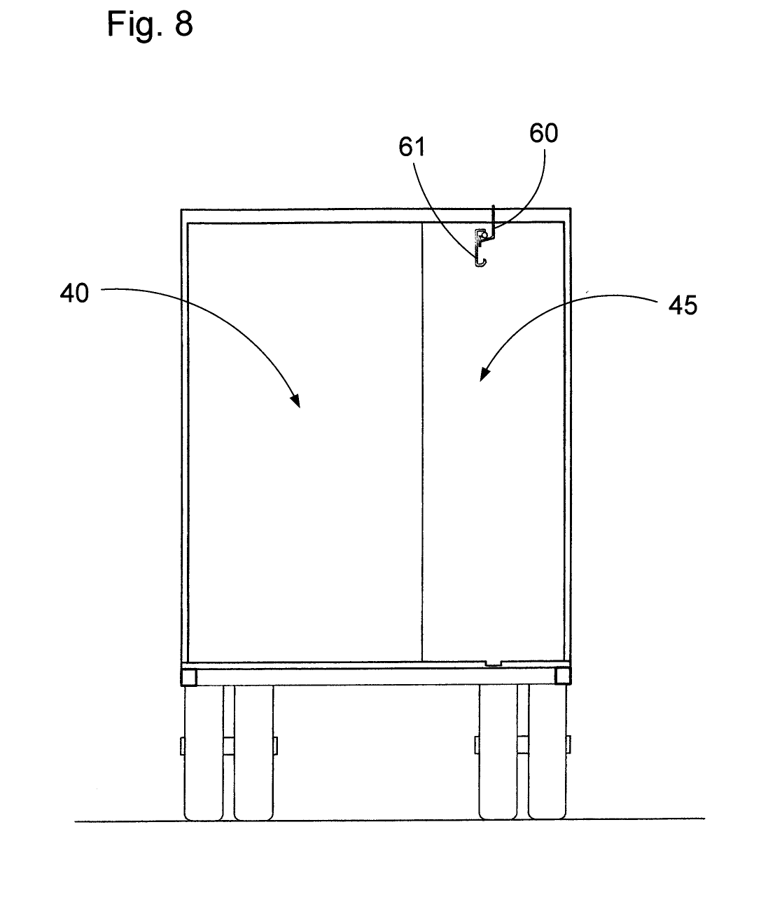

FIG. 9 is a cross-sectional end view looking forward into the meat processing area designated as 46 in FIG. 4.

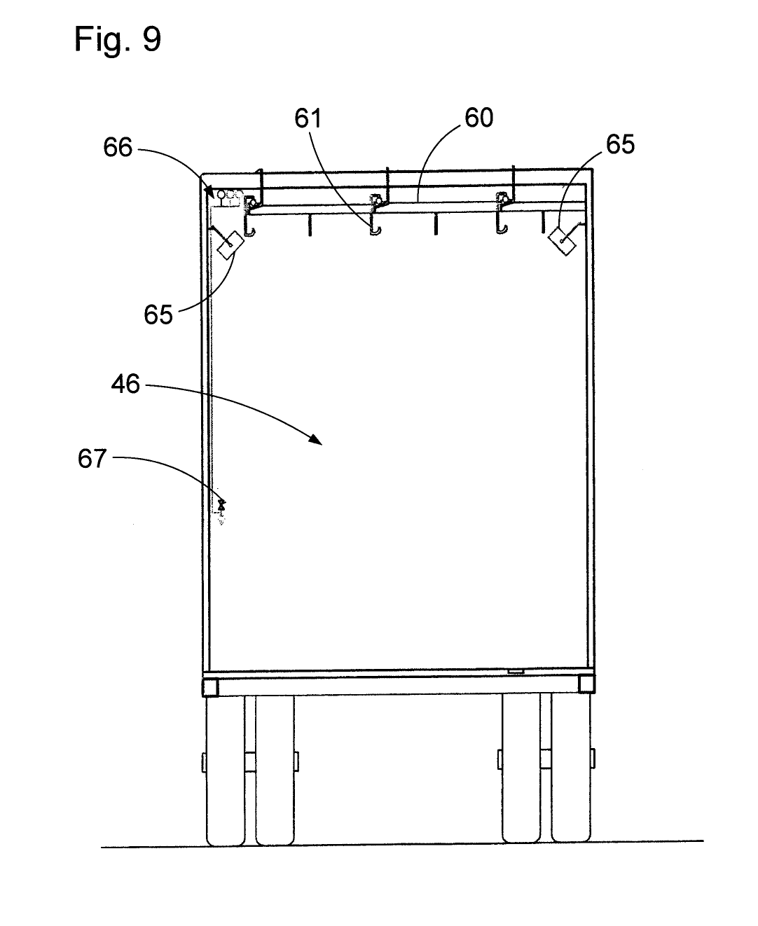

### BEST MODES FOR CARRYING OUT THE INVENTION

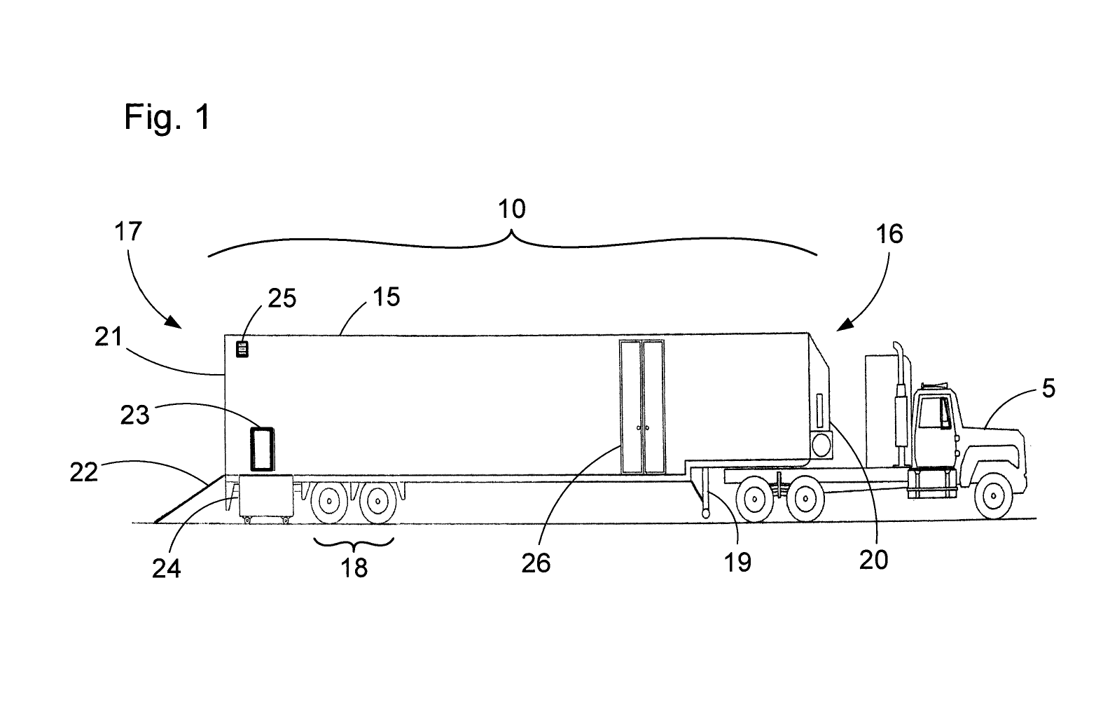

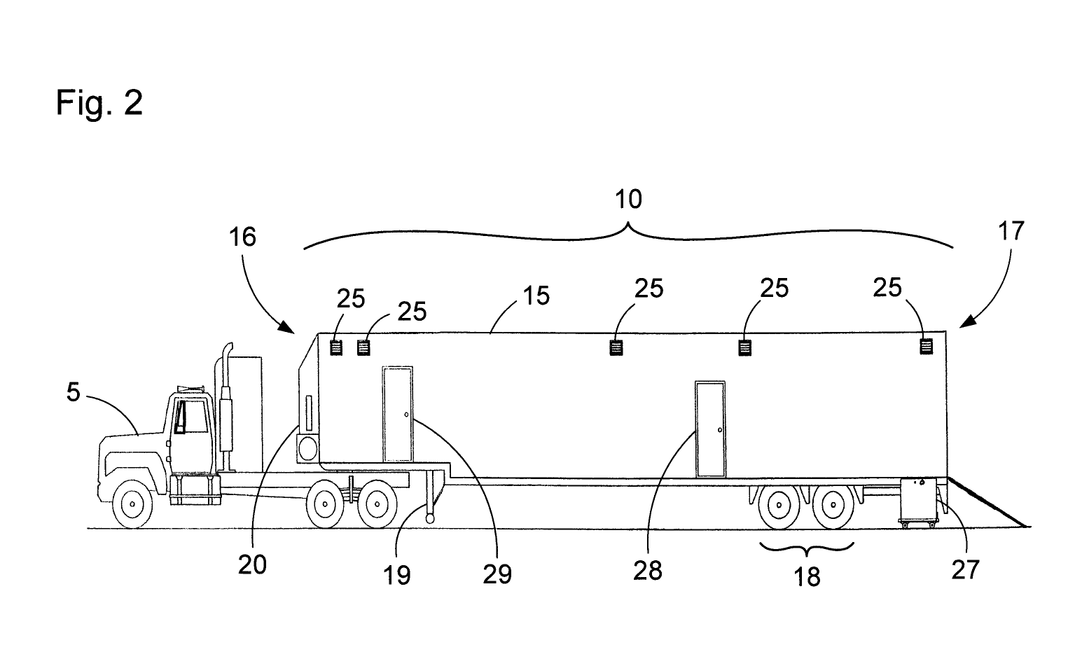

The accompanying drawings show exemplary embodiments of the mobile abattoir of the present invention wherein the mobile abattoir is generally referred by the numeral 10. As can best be seen in FIGS. 1 and 2 which are views, with reference to the rear end 17 of the abattoir, looking at the right and left sides respectively. The mobile abattoir 10 generally comprises a refrigerated tractor trailer unit 15 configured for cooperative engagement with a heavy duty truck 5. It is preferable for the dimensions and configuration of the trailer unit 15 to be selected from the known standards for over-road heavy-duty truck trailers, for example, having an overall length selected from the range of 11 metres to 16.5 metres (i.e., 36 ft. to 54 ft.) and provided with, for example, a bogie-wheel assembly 18, landing gear 19, and a kingpin device (not shown) configured for engaging a truck-mounted fifth wheel assembly. The trailer unit 15 is preferably provided with a first door 26 on the right side approximate the front end 16 of the mobile abattoir, a second door 29 on the left side approximate the front end 16, and a third door 28 approximate the rear end 17 of the mobile abattoir 10. A plurality of spaced apart venting port holes 25 are provided approximate the upper edges of the left and right sidewalls of the trailer unit 15. The mobile abattoir 15 is also provided with a stand-alone gut wagon 24 and a rolling grey water-receiving tank 27. A ramp 22 is preferably provided to cooperatively engage the floor of the trailer unit 15 at its rear door opening 21.

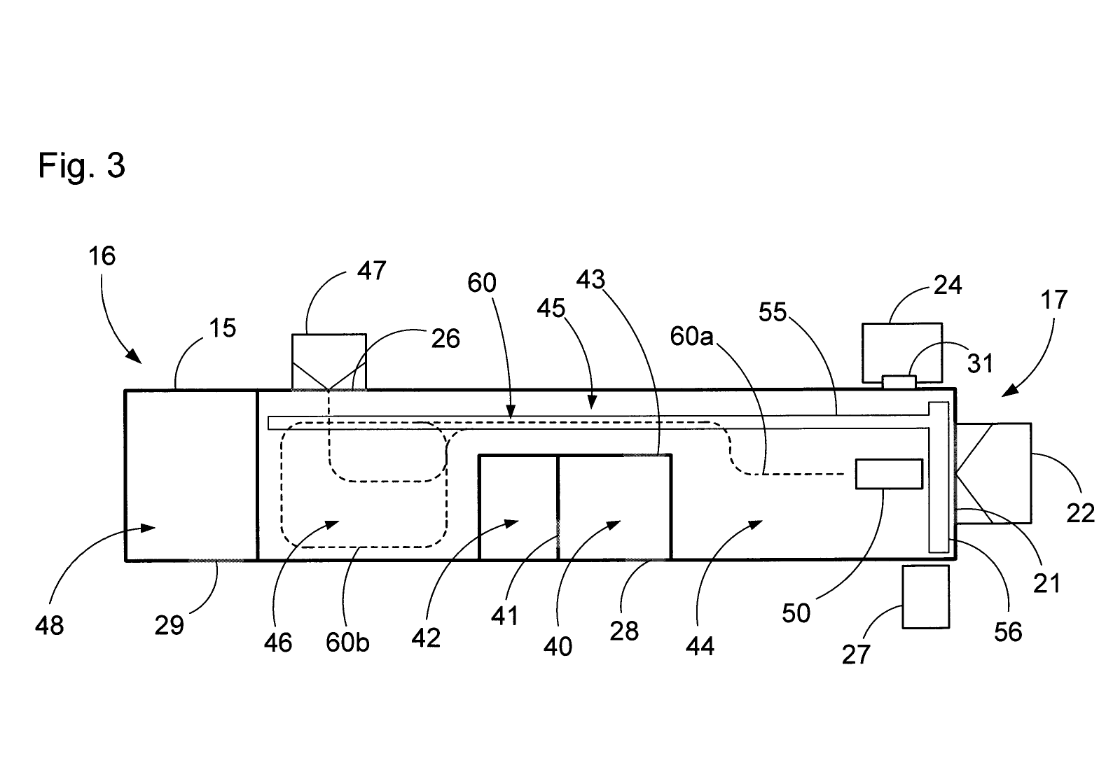

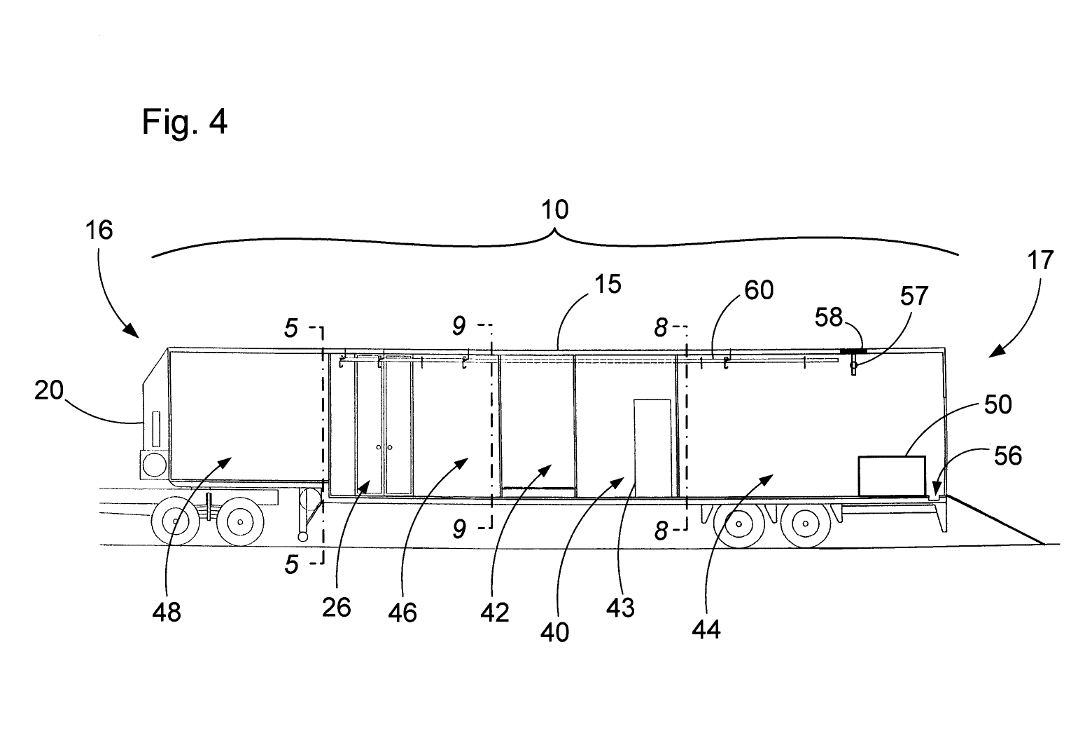

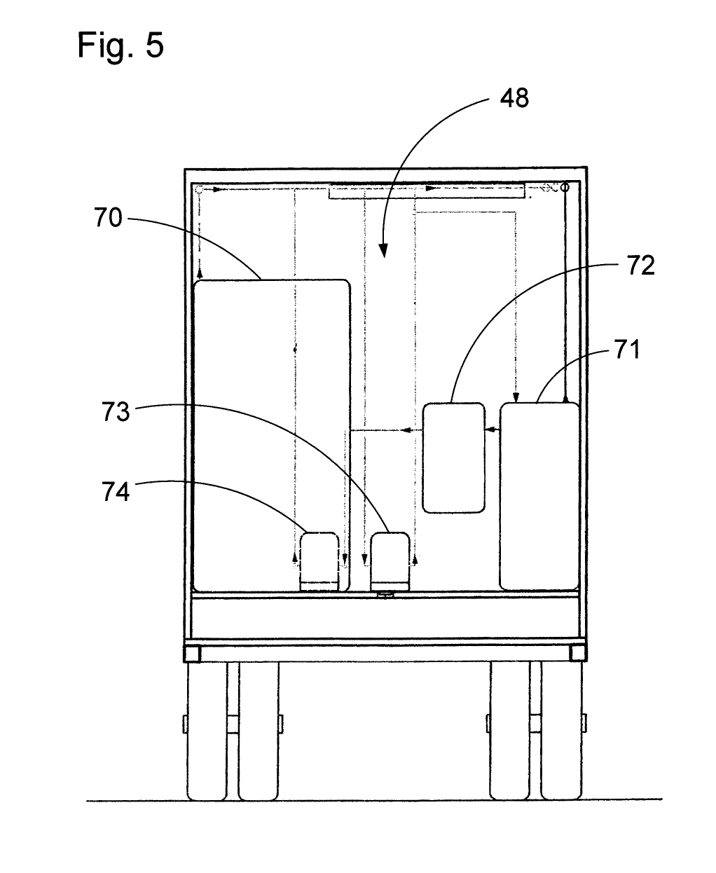

The interior of the trailer unit 15 is configured into a plurality of vertically partitioned interconnecting workspaces. As exemplifed in FIGS. 3 and 4, an enclosed staff room/office area 40 is provided along the left side midsection of the trailer unit 15 through which entry is gained through the third door 28. The staffroom/office room 40 is preferably interconnected with a door 41 to an enclosed and isolated bathroom/wash-up room 42. The area of the trailer unit 15 immediately adjacent to and communicating with its rear door 21 is the animal processing area 44 which leads to a carcass washing & inspection corridor 45 which runs between the right side wall of the trailer unit 15 and the inward-facing end walls of the conjoined the staffroom/office room 40 and the bathroom/wash-up room 42. A door 43 is provided in the inward-facing wall of the staffroom/office room 40 opposite the third door 28, to allow entry from the staffroom/office room 40 into the carcass washing & inspection corridor 45. The carcass washing & inspection corridor 45 leads into a meat processing & chilling area 46 into which the first door 26 on the right side of the trailer unit 15 opens. The framework of first door 26 may be configured for function as a docking station for another trailer unit (not shown) to enable transfer and removal of processed meat from the meat processing & chilling area 46 for transport. An enclosed equipment/utilities room 48 is provided at the front end 16 of the trailer unit 15 and is sealably enclosed and separated from the adjacent meat processing & chilling area 46. Access to the equipment/utilities room 48 is through the second door 27 on the left side adjacent the front end 16 of the trailer unit 15. The equipment/utilities room 48 is interconnected with and cooperates with a diesel-powered motor 20 mounted on the front end 16 of the trailer unit for providing power to operate at least a refrigeration unit 72, an air compressor and pump 73 and an electrical generator 74 (shown in FIG. 5). The equipment/utilities room 48 is also provided with at least a chilled water storage tank 70, a hot water tank 71, and compressed air tanks (not shown).

The trailer unit is preferably provided with: (a) outer surface elements comprising the sidewalls, roof and door elements, and (b) interior ceiling, walls and doors of the trailer unit 15 constructed with sheet materials, such as stainless steel and aluminium, selected for their suitability for ease of surface cleaning, washing, disinfecting and sterilizing according to PR/HACCP regulatory guidelines. If so desired, insulating materials known to those skilled in these arts may be sealingly sandwiched between the outer surface elements and the interior ceiling, wall and door surfaces. Alternatively, the interior ceiling, wall and door surfaces may be abutted against the outer surface elements. The floor of the trailer unit 15 is constructed of a continuous seamless sheet material selected for its suitability for ease of surface cleaning, washing, disinfecting and sterilizing according to PR/HACCP regulatory guidelines. The floor is provided with a recessed elongate channel 55 extending from approximate the wall separating the equipment/utilities area 46 and the meat processing & chilling area 46 through the carcass washing & inspection area 45 and terminating in a trough 56 extending from approximate the left side to the approximate the right side of the trailer unit adjacent the rear door 21. The trough 56 is provided with a discharge valve (not shown) at its end adjacent the left side of the trailer unit 15. The junctures of the floor, inner walls and ceiling are preferably sealably engaged for example by running a welding bead along the junctures of two metal sheet materials or alternatively, by running a bead of suitable caulking materials.

The ceiling of the trailer unit 15 is provided with a reinforcing beam 58 extending between and supported by the left and right sides of the trailer unit 15. A winch and hook assembly 57 is suspended from the supporting beam approximately midway between the left and right sides of the trailer unit 15. A rail track system 60 is supported from the ceiling of the trailer unit 15 and generally extends and traverses from the animal processing area 44 along the carcass washing & inspection area 45 to and about the meat processing & chilling area 46 and terminates adjacent the first door 26 generally along a path as exemplified in FIG. 3 by dotted line 60a. A plurality of conveying hooks 61 is provided along the rail track system 60.

The configuration and outfitting of the mobile abattoir of the present invention enable humane handling and treatment of animals immediately prior to and during the slaughtering process, and subsequently enables the processing of slaughtered animals, i.e., de-heading, bleeding, evisceration, de-hiding, followed by washing and splitting the carcass (and quartering if so desired), grading, and chilling under hygienic and inspection conditions as specified by PR/HACCP regulatory guidelines. Furthermore, the quality of meat harvested with the mobile abattoir of the present invention is not compromised by physical and hormono-chemical stresses caused by extended shipping and rough shipping handling.

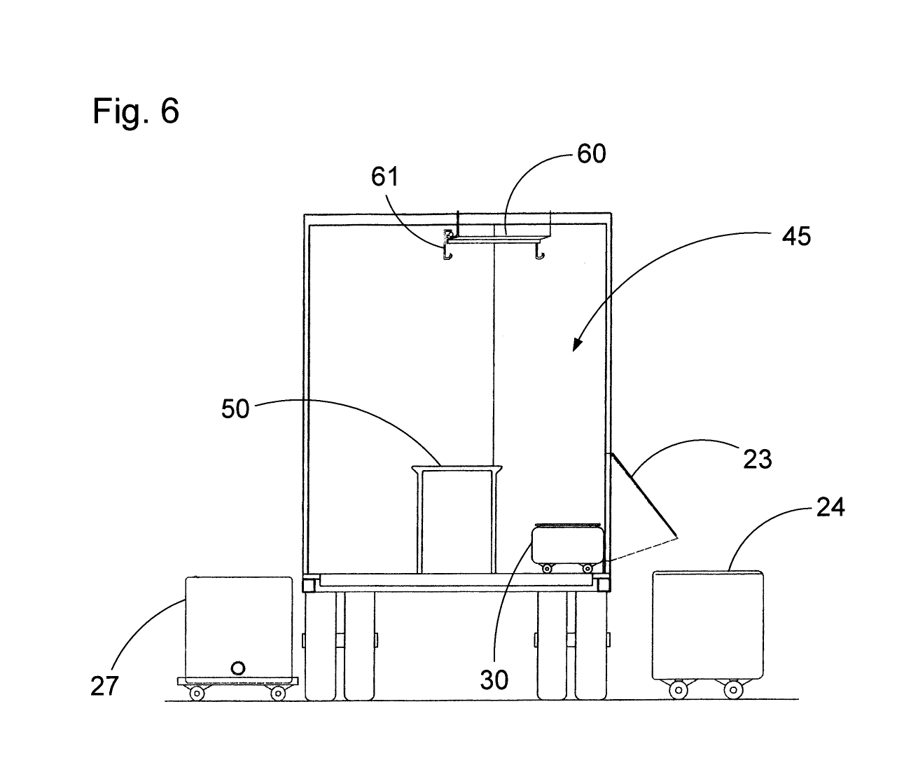

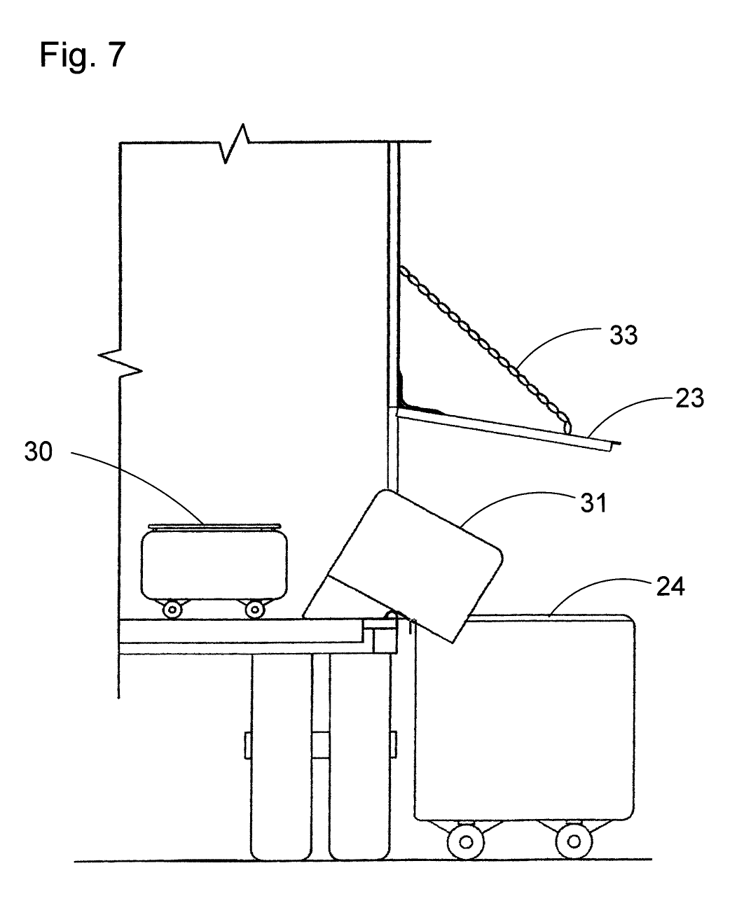

An animal to be processed within the mobile abattoir of the present invention is stunned or killed following procedures specified by Federal regulations, and then is hoisted into the air by means of an external devise such as a front-end loader tractor or alternatively, by an hydraulic boom attached to the back of the abattoir (not shown) after which the animal is bled into a suitable container and its head removed and placed into a head rack provided therefore. The animal is then lowered to the ground and the winch line 57 is attached to its back legs using a suitable spreader-bar hook assembly (not shown). The animal is then winched up the ramp 22 into the slaughtered livestock reception area 44 inside the back end of the mobile abattoir and placed into the cradle 50, using the winch to aid in raising the animal above the floor. The animal is then de-hided with an air-pressure-powered de-hider after which it is eviscerated into a gut-receiving wagon 30 (FIG. 6). Certain internal organs as specified in PR/HACCP regulatory guidelines and exemplified by the heart, kidneys and liver are separated and harvested from the remaining viscera during the evisceration process, and are placed on sanitary work stations (not shown) provided therefore in the animal processing area 44. As shown in FIG. 7, the viscera in the gut-receiving wagon 30 are removed from the animal processing area 44 by rolling the gut-receiving wagon 30 to the right side of the trailer unit 15 where they are dumped into a gut chute 31 into a gut wagon 24 adjacent the right side of the trailer unit 15 through an aperture normally covered by a gut chute cover 23. The gut chute cover 23 may be held in an open position during use by a support chain 33 if so desired. After the slaughtered animal has been eviscerated, the carcass is transferred from the winch and hook assembly 57 to a conveying hook 61 on the conveying rail track system 60 where it is then split in half and the halves moved to the carcass washing & inspection area 45. After the carcass halves have been washed and inspected, they are moved to the meat processing & chilling area 46 for further processing, chilling and storage. After the washed and inspected carcass is moved into the meat processing & chilling area 46, the ceiling, walls and floor of the carcass washing/inspection area 45 and the animal processing area 44 are washed down with pressurized water followed with a disinfecting/sanitizing solution. The floor throughout the work areas 46, 45, and 44 is sloped toward the elongate channel 55 and trough 56 so that the washings drain into the channel and flow into the trough, from where they are dispensed through the discharge valve (not shown) into the grey water tank 27. The design, configuration and use of the mobile abattoir as disclosed herein enable the efficient hygienic slaughter according to PR/HACCP regulatory guidelines of about 15 to 20 animals the size of beef cattle and bison, and or of about 25 to 35 animals the size of sheep, lambs and goats in a single work shift by two to three personnel under the inspection of a Federal agency veterinarian.

The conveying rail track system 60 is securely engaged with the ceiling of the trailer unit, and is laid out in a pattern configured to move eviscerated livestock carcasses from the slaughtered livestock reception area 44 through and about the interconnected workspaces 45, 46. The conveying rail track system 60 may optionally be configured to communicate with the first door 26 through the sidewall 15 into the carcass processing, chilling and storage area 46. The conveying rail track system 60 may comprise a spur portion 60a that is communicable and cooperable with at least one continuous loop portion 60b. Alternatively, the conveying rail track system may comprise a plurality of continuous loops (not shown) interconnecting the different workspaces 44, 45, 46, whereby the direction of travel is continous in one direction along each loop. The conveying rail track system 60 is suitably provided with a plurality of demountable spaced-apart hooks for suspension therefrom. The hooks are suitably configured for releasably engaging livestock carcasses and portions thereof. It is suitable for the conveying rail track system 60 to be motor driven (not shown). The motor may be configured to provide a driving force in one direction, which would be particularly well suited for a system comprising a plurality of continuous loops. Alternatively, the motor may be configured to provide reversible driving forces, i.e., in forward and backward directions. The reversible motor configuration is suitable for conveying rail track systems comprising: (a) a spur portion and a continuous loop portion, and (b) a plurality of continuous loops.

It should be noted that it is within the scope of the present invention to provide and configure temperature-controlling equipment and ductwork (not shown) within and throughout the mobile abattoir 10 to enable precise temperature control and air circulation in the different areas regardless of the ambient outdoor temperature. For example, each of the animal processing area 44, the carcass washing & inspection area 45, and the meat processing & chilling area 46, can be maintained at a temperature selected from the range of 4° C. to 15° C., and furthermore, it is possible if so desired, to maintain the animal processing area 45 at a temperature of about 10° C., concurrently with the meat processing & chilling area 46 at a temperature of about 2° C., while the carcass washing/inspection area is maintained as a temperature transitional zone from 10° C. adjacent the animal processing area 45 to 2° C. adjacent the meat processing & chilling area 46. It is within the scope of the present invention to alternatively provide one or more refrigeration units mounted on the roof of the trailer unit 15 directly over one or more work areas.

The location and configuration of the staff room/office area 40 and bathroom/wash-up area 42 provide a space for abattoir and inspection staff to enter the mobile abattoir 10, put on protective clothing, wash and disinfect their knives, tools and instruments, and then enter the carcass washing/inspection area 45, animal processing area 44, and meat processing & chilling area 46.

While this invention has been described with respect to the preferred embodiments, it is to be understood that various alterations and modifications can be made to the components and internal configuration of the internal areas of the mobile abattoir within the scope of this invention. For example, meat-packaging equipment exemplified by vacuum-sealing equipment may be provided in a work space to facilitate packaging of butchered carcass portions. It is also suitable if so desired, to provide meat sterilization equipment within a workspace or alternatively, connections for communicating and cooperating with external sterilization equipment as part of the meat packaging workspaces.

1. A self-contained mobile abattoir configured for receiving and processing therein slaughtered livestock and separately egressing therefrom carcass portions and offal according to Inspection Agency regulatory standards, said self-contained mobile abattoir comprising:
a towable enclosed trailer unit having a front end and a back end, a bogie-wheel assembly approximate the back end of the trailer unit, a landing gear assembly approximate the front end of the trailer unit, a hitching device approximate the front end of the trailer unit, and a power-generating apparatus engaged with an external surface of the trailer unit;
a plurality of vertically partitioned interconnected workspaces contained within the enclosed trailer unit, said spaces configured for hygienic performance of skinning and skin disposal, carcass cleaning and inspection, evisceration, viscera separation and inspection, butchering and meat inspection operations, said interconnected workspaces additionally sealably configured for controllable collection and disposal of offal, bodily fluids, washing fluids and sanitization fluids, wherein the inner-facing surfaces of the enclosed trailer unity and vertical partitions defining the workspaces comprise materials according to Inspection Agency regulatory standards;
an enclosed equipment space approximate the front end of the trailer unit, said equipment space sealably separated from the interconnected workspaces and communicable with the power-generating apparatus, said equipment space provided with a plurality of equipment, instruments, and controlling devices configured for controllably producing and delivering to the interconnected workspaces at least electricity, compressed air, hot water, chilled water, and refrigeration;
an enclosed staff services area separated from the interconnected workspaces by a sealable door, said staff services area provided with at least a lavatory, a washup facility and a changing facility according to Inspection Agency regulatory standards, said staff services adjacent a side wall of the enclosed trailer unit provided with a sealable door therethrough;
a conveying track rail system depending from the ceiling of the trailer unit and configured to provide a route for moving a plurality of carcasses suspended from suitable devices communicating and cooperating with the track rail system, from a slaughtered livestock reception area approximate the backend of the trailer unit about and through the interconnected workspaces; and
a winch and hook assembly cooperable with a mounting device engaged with the ceiling of the trailer unit above the slaughtered livestock reception area.

2. The self-contained mobile abattoir according to claim 1, wherein the power-generating apparatus is a motor powered by a fuel selected from the group consisting of gasoline, diesel, ethanol, propane, butane and derivatives thereof.

3. The self-contained mobile abattoir according to claim 1, wherein the equipment space is provided with at least one tank configured for containing and storing therein at least one of hot water, chilled water and compressed air.

4. The self-contained mobile abattoir according to claim 1, wherein at least one first holding tank is provided underneath the trailer unit for receiving and containing therein bodily, washing and sanitization fluids, said one first holding tank controllably communicable with at least one of the interconnected workspaces.

5. The self-contained mobile abattoir according to claim 1, wherein at least one second holding tank is provided underneath the trailer unit for receiving and containing therein offal, said one second holding tank controllably communicable with said slaughtered livestock reception area.

6. The self-contained mobile abattoir according to claim 1, wherein a sealable demountable chute is provided approximate the slaughtered livestock reception area for controllably discharging offal therefrom.

7. The self-contained mobile abattoir according to claim 1, wherein each of the interconnected workspaces is temperature controllable.

8. The self-contained mobile abattoir according to claim 7, wherein at least one of the interconnected workspaces is configured as a meat-chilling and temporary storage space.

9. The self-contained mobile abattoir according to claim 8, wherein a sidewall of the trailer unit is provided with a sealable door for controllable ingress to and egress from the meat-chilling and temporary storage space.

10. The self-contained mobile abattoir according to claim 1, wherein the inner-facing surfaces of the enclosed trailer unity and vertical partitions defining the workspaces are cladded with sealingly conjoined sheeting materials according to Inspection Agency regulatory standards.

11. The self-contained mobile abattoir according to claim 10, wherein the inner-facing surfaces of the enclosed trailer unity and vertical partitions defining the workspaces are cladded with sealingly conjoined sheeting selected from the group consisting of metal sheeting, composite sheeting, and plastics sheeting.

12. The self-contained mobile abattoir according to claim 10, wherein the inner-facing surfaces of the enclosed trailer unity and vertical partitions defining the workspaces are cladded with sealingly conjoined stainless steel.

13. The self-contained mobile abattoir according to claim 1, wherein the conveying track rail system comprises at least one spur portion communicating with at least one continuous loop portion.

14. The self-contained mobile abattoir according to claim 1, wherein the conveying track rail system is provided with a plurality of demountable hooks configured for suspending livestock carcasses therefrom.

15. The self-contained mobile abattoir according to claim 1, wherein the conveying track rail system is motor driven.

16. The self-contained mobile abattoir according to claim 15, wherein the motor-driven conveying track rail system is drivable forward and backward.

17. The self-contained mobile abattoir according to claim 1, wherein the mounting device cooperable with the winch and hook assembly is configured for controllably extending the winch and hook assembly out of the back end of the trailer unit and then controllably retracting said winch and hook assembly back into the slaughtered animal reception area.

18. The self-contained mobile abattoir according to claim 1, wherein the winch and hook assembly is cooperable with the conveying track rail system.

19. The self-contained mobile abattoir according to claim 1, wherein at least one of the interconnected workspaces is provided with a worksurface according to Inspection Agency regulatory standards.

20. The self-contained mobile abattoir according to claim 19, wherein the worksurface is selected from the group consisting of fixed-in-place worksurfaces, collapsible worksurfaces, and foldable worksurfaces.

21. The self-contained mobile abattoir according to claim 1, wherein at least one of the interconnected workspaces is provided with meat-packaging equipment.

22. The self-contained mobile abattoir according to claim 21, wherein the meat-packaging equipment comprises vacuum-sealing equipment.

23. The self-contained mobile abattoir according to claim 21, wherein the workspace provided with meat-packaging equipment is communicable with meat sterilization equipment according to Inspection Agency regulations standards.
